(19) United States
(12) Patent Application Publication
(10) Pub. No.: US 2001/0049824 A1
(43) Pub. Date: Dec. 6, 2001

(54) Internet business model for the production, market making and distribution of audio and multimedia programs

(76) Inventors: Stanley C. Baker, San Jose, CA (US); Laurence H. Cooke, Los Gatos, CA (US)

Correspondence Address: Michael Hetherington, Woodside I P Law Group, P. O. Box 620839, 120 Langley Hill Road, Woodside, CA, 94062, US

(21) Appl. No.: 09/769,093

(22) Filed: Jan. 24, 2001

Related U.S. Application Data
(60) Provisional application No. 60/177,817, filed on Jan. 25, 2000.

(51) Int. Cl. H04N 7/025; H04N 7/10; H04N 7/173

(52) U.S. Cl. 725/109; 725/36

(57) ABSTRACT

An Internet business model for conducting distribution of audio and multimedia programs, including the buying and selling of the advertisment space in the programs, integrating the selected ads into the programs, and distributing them to the listeners/viewers, using the internet. The Method includes techniques for accounting for royalties and fees associated with the distribution of the programming content as well as a open market for ad slot pricing based on consumer demand.

### RELATED APPLICATION

This patent application is based upon U.S. Provisional patent application Ser. No. 6,0177,817, filed Jan. 25, 2000.

### FIELD OF THE INVENTION

The field of the present invention relates in general to a method and system for bringing audio and multimedia content creations from authors/owners to consumers of audio and multimedia content. More particularly, the field of the invention relates to a business model which provides a market for owners of audio and multimedia content by automating the integration of audio and multimedia content with sponsor advertisement embedded into programs for distribution to consumers over the Internet. The system includes feedback mechanisms which provide continous automatic distribution popularity ratings based upon consumer demand. This in turn provides for market pricing sponsorship and hence revenues to authors/owners, commensurate with demand for their works.

### BACKGROUND

Traditionally, the television/radio broadcast industry selects a limited set of programs and provides them free to their viewers/listeners along with embedded advertisments. The advertisments pay for the broadcasting and the programming. The number of people view or hear the ads is measured statistically by such companies as Nielson, which who rates the popularity of programs. The ratings ultimately determine the price of the advertisments. The length of an advertisment usually varies from 15 to 60 seconds, with multiple advertisements embedded between segments of program content.

About a decade ago the cable industry began making significant inroads into the broadcast television industry. Cable companies offered many more channels of programming, which gave rise to programming focused more on special interests such as the History channel or Home and Garden TV. As the public recognized the added choices cable provided, the size of the cable industry's audiences and amount of advertising grew. More recently, satellite broadcasting also made available many more channels for viewing and listening by cable customers. However, both the cable and satellite broadcasting changed little more than the number of channels that could be viewed, not the advertising, content or programming structure. Typically, studio or network executives decide what programs to promote, what programs will air and when. What is needed are ways whereby consumers have more input into what they are able to view and when they wish to view the content without charge or payment.

A new form of Internet based audio entertainment recently has emerged. So-called Web Radio provides music and radio programs which can be downloaded from a Web Radio web site on the Internet. Most of the companies that produce Web Radio programs generate their revenues through banner advertisements on their web pages, and not from advertisements embedded in the programs. However, some companies are beginning to put advertisements into their programs. Web Radio companies are using the Internet to provide thousands of new choices to their listeners. This is possible because the cost of distribution via the Internet is so low. Other companies have started to provide portable devices, similar to CD players, that can play the music and other audio programming from web sites after downloading the programs (such as audio files) to a personal computer, then into the device. With the ease of portable listening and thousands of choices, this form of entertainment is growing rapidly, with new web sites opening every month.

However, none of these solutions provide a way for the musician or developer of the programming to generate revenue without going through the gatekeepers of the publishing and broadcasting industries. The gatekeepers are those who decide what programming to provide the mass consumer markets. For the music industry, it is radio stations and record (now CD) publishers who decide what programming to promote. This is also true for television and television networks. What is needed are new ways to allow consumers to decide what programming content will be made available for viewing.

The artist's work is not bought or shown unless the gatekeepers promote it. Web Radio is providing musicians and developers of other audio programming low cost exposure to their audience, but does not provide royalties for their work. Currently, the web's radio stations use advertising on their sites to obtain revenue for themselves, not for the content providers. As a result, the content providers are still separated into the “haves,” who are promoted by the gatekeepers, and the “have nots.” On the other hand, gatekeepers are also promoters. They often advertise an artist's work to provide more visibility to the artist. None of the existing systems allow a seamless interface between exposure with and without being selected by a “gatekeeper”. What is needed are ways for artists to market their work more directly so that they have a better chance of exposure without getting filtered out by gatekeepers.

Innovation in programming is stifled because the gatekeepers cannot always guess what the public wants or will value in new programming. Small advertisers are also locked out of broadcasting to a broad audience because of the high price of mass media television and radio advertising. Therefore, what is needed is more direct access to advertise at lower prices in programs that have small audiences and markets, but with the full worldwide reach of the Internet. Furthermore, what is also needed is a market model which can support sponsorship with embedded advertisements in audio and multimedia content which consumers can chose directly. What is needed are ways to get larger numbers of smaller creators of audio and multimedia content directly to consumers thereby providing a more diverse selection for consumers.

The anticipated methods of distribution of digital audio and multimedia content are the replacement of film and CD distribution by charging customers for downloads of individual songs or movie titles. This may be superseded in part because the search space of possible audio and multimedia clips is so huge. Instead, some record companies will turn to a subscription-based service for a particular artist, in which a monthly fee will allow a select community to receive all new works by an artist for that month. In this model, the current MP3 promoters who post bootleg live performances to Web sites will be encouraged to join communities of interest, similar to fan clubs, where they will be given incentives to post semi-legitimate recordings of an artist to a fan group and become part of an informal licensing structure. What is needed is an alternate way of shifting the financial burden of payment for content to sponsors, which will demotivate bootleggers, but allow consumers to receive the audio or multimedia content they desire with the interleaved commercial messages and yet still provide all the other needs mentioned above.

### SUMMARY OF THE INVENTION

An aspect of the invention provides Internet broadcasting facilities and web sites for distribution of audio and multimedia programming. This provides a market for both programs and associated advertisements without the current constraints of or need for a large production studio or network for development or transmission. Currently, a fee is charged to an advertiser for the transactions associated with buying advertisements in programs. A fee is also charged to the program producers for the distribution of programs. Beyond these fees, the bulk of the advertisement charges are transferred to the owner of the programming.

An aspect of the present invention provides the artists and producers that create programs with a readily available, non-discriminatory market in which to sell their creations. The instant system is also flexible enough to allow the broadcaster to act as a middleman between the advertiser and the program producer in the traditional manner, wherein the broadcasters own the advertising spaces, contract with program producers and advertisers for their use, and promote the final product.

The invention model is implemented through the use of programming automation, computer tools, a central exchange website or portal communicatively linked to an electronic computer network such as the Internet employing a large variety of consumer player/viewer devices, such as but not limited to PC's, non-PC personal video recording/playing systems, Digital TV, WebTV, ITV, handheld audio/video players, wireless devices or the like.

An aspect of the invention provides a computer tool to the program producers, also called owners, which formats the owner audio or multimedia content to accept advertisements. It also provides a different computer tool to the advertiser to format its advertisements to be compatible with the programs and an integrated data base with GUIs for buying and selling advertisements and programs as well as distributing the programs to the listeners or consumers in various existing audio or multimedia codecs, compression schemes, encryption algorithms and digital formats standard.

The foregoing tools provide a way to sell programming and advertisment both via an intermediate promoter and broadcasters, and directly between advertisers and content producers through a free and open competitive market for advertisements and owner content. An aspect of the invention model also provides a more effective broadcasting of programming to allow the public more options concerning what to view or listen to and when, through a growing selection of player devices and at lower costs of distribution than other methods, employing the Internet and associated communication technologies.

A further aspect of the present business model provides program developers or owners with revenue that is proportional to the consumer interest in their works. Success of programs is measured by the “hits” (number of downloads demanded by listeners or viewers) received. These statistics are published on the website or made available to the public by other means. Presently, only a few large production/broadcast studios, networks or cable companies are in the position of choosing which programs to broadcast. In contrast, an aspect of the present invention provides a market system which directly rewards program developers according to direct consumer demand, thus encouraging further development of what the public wants in a far more efficient manner than is currently possible.

### BRIEF DESCRIPTION OF THE DRAWINGS

FIG. 1 shows a high level system functionality in terms of the Automatic Control system, Compose system, Broadcast system, Integrated Programs, Program Segments, Listener Content, according to an aspect of the invention.

FIG. 2 is a high level flow diagram showing Content Composer, Ad Composer, and Segment Composer which create program, ad, and segment composed files, which are stored and combined with listener input to compose finished programs, according to an aspect of the invention.

FIG. 3 depicts the composite file form or layout structure of program files created by the content composer using the makefile type approach according to an aspect of the invention.

FIG. 4 shows the high level structure of files with ad links which combines segments and inserts the ads to create a packaged composite program according to an aspect of the invention.

FIG. 5 shows an example of a web page used to sell and purchase ad slots according to an aspect of the present invention.

### DETAILED DESCRIPTION

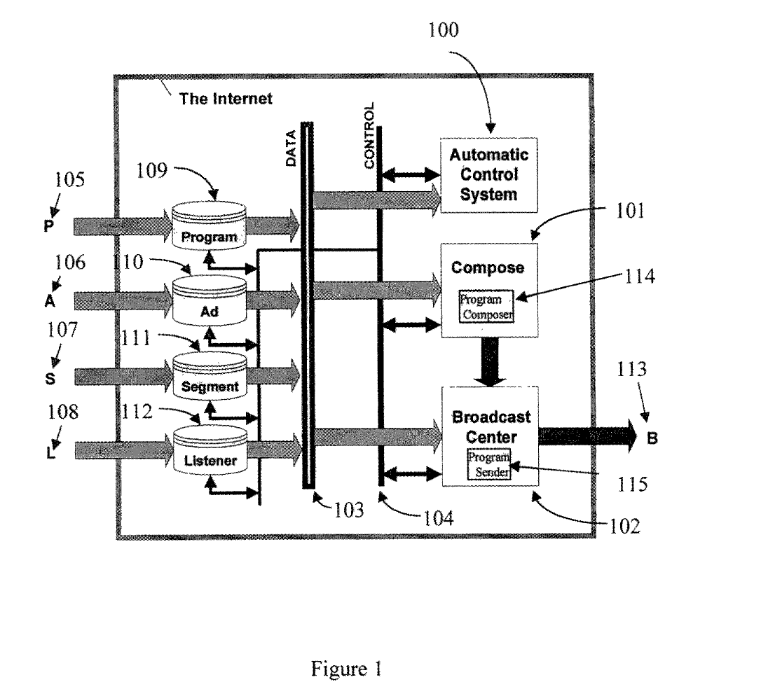

In a preferred embodiment of the invention, as shown in FIG. 1, an integrated data base within the automatic control system(100), ACS, contains the control, value, attribute and meta information associated with programs(109), advertisements(110), program segments(111), producers, advertisers and listeners(112), with control(104) and datapath(103) links to the specific files that hold the content of programs and advertisements. The ACS is defined to mean the computer program which manages the content packaging process into the various digital structures and formats that can be broadcast, multicast or otherwise electronically transferred to consumers (113) in data streams of requested format compatable audio or multimedia content. There are also a number of application specific software programs; content composer(201), ad composer(202), segment composer(203), program composer(114), program player, database archiver and retriever (100), and program dispatcher(115) which all work in concert to collect various content from disparate sources such as producers/owners (105, Advertisers/sponsors (106), Audio segments (107), and listeners/consumers (108); receive and store input or request data (109) (110) (111) (112) respectively. These functions provide the means for owners(105) of audio or multimedia program content, sponsors with ad content (106) and authors of segments (107) to load their content onto the exchange website for consumer bound (113) distribution.

Upon request (108), these can at any time be packaged and reformated composite into standard format files (303) which can be distributed to requesting consumers on the Internet. The distribution methods may include but are not limited to conventional Internet protocols such as ftp, http, shttp, encryption etc as needed to satisfy consumer demand for speed and player devices compatability. These will enter the Internet portal from the various Internet Producers or owners (105), Advertisers or sponsers (106), Segment or audio pieces authors (107) and listeners or consumers (108). The system output from the Broadcast Center (113) will like fashion employ Internet protocols to transfer packaged programs (404) standard format (MP3, MPEG-2, MPEG-4) compliance with consumer requests (108) for audio or multimedia content as well as compatable with consumer viewer/player devices. These can be any player/viewer device compatible with Internet protocols and industry standard format streams such as but not limited to PCs, non-PC personal video recorder/player systems, Digital TV, ITV, handheld a/v players, wireless devices and the like.

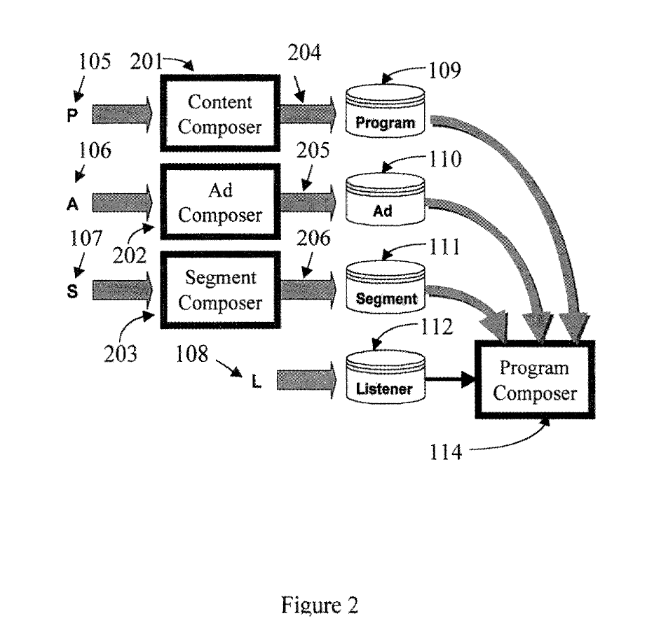

As shown in FIG. 2, the program producers use the content composer(201) to create content (programs)(204) which are downloaded to an assigned storage area in the database. Other types of content providers, such as musicians, create segments(107) (portions of programs, individual tracks of albums, etc.) by using the segement composer(203). The segments(206) are then transferred to their assigned storage area depicted in the figure as segment disk area(111). The advertisement producer creates ads(205) using the ad composer(202) and downloads the ads to the ad storage area disk (110). Typically, the programs or segments and ads are linked into complete programs using the program composer(114) in the Compose box(101), then electronically transferred to the Broadcast Center(102). The listeners can compose their own programs from segments, remotely via the communication link or Internet. Their program composition instructions flow to the program composer(114), via the control interface(104) as shown in FIG. 1, where their choices are linked into the desired program. Alternatively the listener/consumer may select programs that have already been composed and are available. Advertisements may be embedded automatically in these listener-composed programs. The listener then downloads, via the Broadcast center program sender(115) and plays the audio selections using a compatable device player. If listeners want regularly produced programs they can request the selected new programs before they become available. Shortly after a program becomes available the program sender(115) will tramsmit it in a manner most appropriate for the receipient consumer requestor. Such transmission methods include wired or wireless, TCP/IP file transfer, Broadcast streaming, or other suitable internet transfer mechanisms..

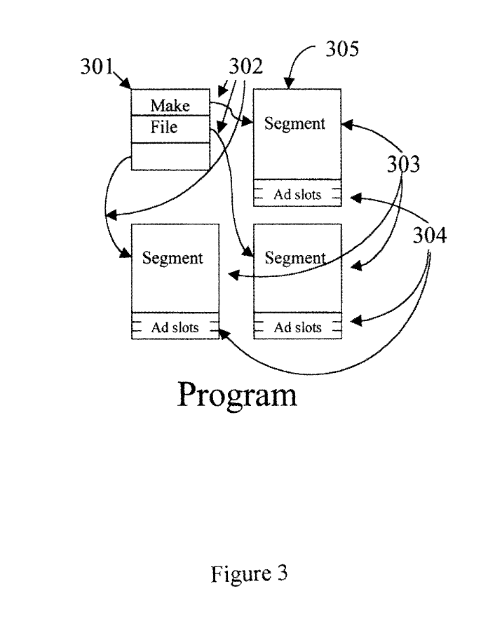

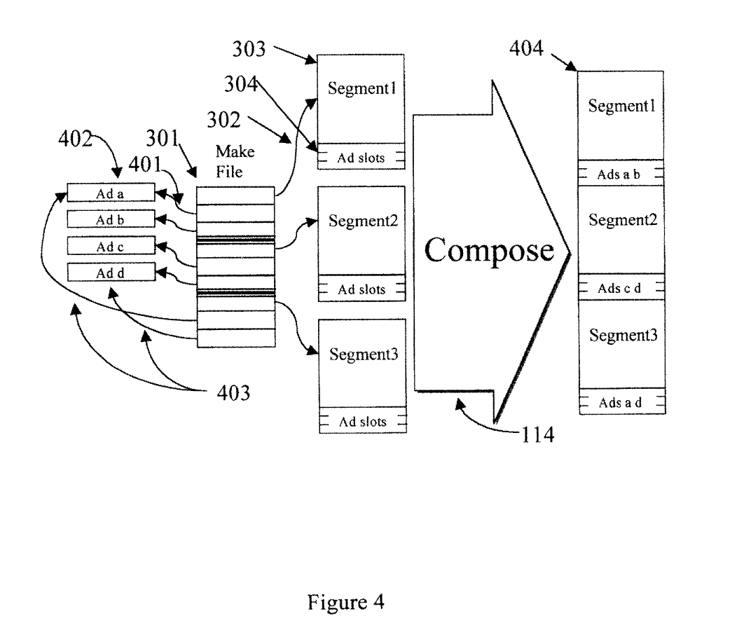

Referring to FIG. 3, in one embodiment the segment composer(203) converts the segment into an MP3 file(303) or alternate acceptable digital file format, and uses the text records of the file to define a block (group) of time intervals for ads to be placed. These intervals are called ad slots(304). These are typically 30 seconds each with 2 or more in one block. The content composer breaks the programs into segments, calls the segment composer(203) and creates a makefile(301) to define the order of the segments(305) to be used in the packaged output file build, as shown in FIG. 3. The ad composer(202) converts advertisements(106) into MPEG format files, checks for unacceptable offensive words and phrases, assigns the ad in portions based on an integral number of slots, and adds the information to the text records of the MP3 file(205). The program composer(114) takes a control input, in the form of a make file(301), and integrates the audio ads(402) defined in the makefile(301) with the audio program segments(305) and creates one integrated MP3 file with control information for distribution(404), as shown in FIG. 4. It does this by tracing the links to the ads in the makefile(401) to obtain the appropriate ads to integrate into each ad slot (304) in each segment(305). It then integrates together the segements pointed to by the makefile(302) into the single packaged MP3 file. In another embodiment the program also encrypts the resulting integrated file. This process provides a means for merging owner audio or multimedia content (303) with sponsor provided content (402) into packaged programs (404) standard viewer/player device formats requested by consumers for distribution (115).

In one embodiment, the program sender(115) uses a control file which is extracted from the integrated database. This control file is created periodically and asynchronously and contains a list of newly available programs and the list of listener's that have requested each program. This control program then transfers the appropriate program files to each listener on the requester list via the most appropriate internet transfer mechanism available as opted for by requester.

In one embodiment, the program player checks the audio program file for an expiration date or play restrictions. It then either decrypts the file and “plays” it for the listener on the listener's computer or deletes the file and provides the listener with an explanation about which restriction or expiration condition caused the erasure.

In another embodiment these audio files in the other embodiments may be multimedia files, using MPEG2, MPEG4 or other suitable multimedia formats.

In the preferred embodiment, the Broadcast Center(102) contains a hiarchy of web pages with the appropriate user navigator GUIs to search on content subjects, titles, sponsors, current ad slot prices, authors/owners, producers, performers etc, and obtain lists of programs and segments currently available. These web pages are hosted on the website and are dynamically updated from data in the integrated database in the ACS (100). Programs may be either requested or subscribed to by listeners by navigating the web pages and entering options and selections. Programs may be free to the listener or paid for depending on tolerance for sponsor ads and willingness to pay. When a program is scheduled for broadcast, the broadcast center(102) checks the list of subscribers (which is defaulted to everyone with a wildcard entry) to see who is authorized to receive the program. It then releases the program or segment for composition or for downloading by the subscriber/listener. The program composer(114) will integrate specific ads (402) that have been purchased into their appropriate slots(304) at this time. Otherwise the program or segment is added to the released database and it's name and link are added to the appropriate web page. When a listener requests the program, or segment, the program composer(114) is again called to incorporate other ads in the remaining unused ad slots It then integrates the segments or program into one MP3 file(404), as for example in an audio content request. This provides a means for integrating owner audio or multimedia (303) content with sponsor advertisement content (402) and formatting into standard audio or multimedia streams (404) compatable consumer player/view devices.

The broadcast center (102) will also download the program player if requested. The broadcast center (102) will also add the subscriber/listener's name to the list for any future program that they are authorized or requested to obtain, which will result in an appropriate internet electronic transmission of the program on the next execution of the program sender(115) shortly after the program is available. In another embodiment the Broadcast Center(102) also collects financial and social data from subscribers in lieu of payment of subscription fees, to provides e-mail distribution and statistically estimate the interests and distributions of listeners, according to selected parameters.

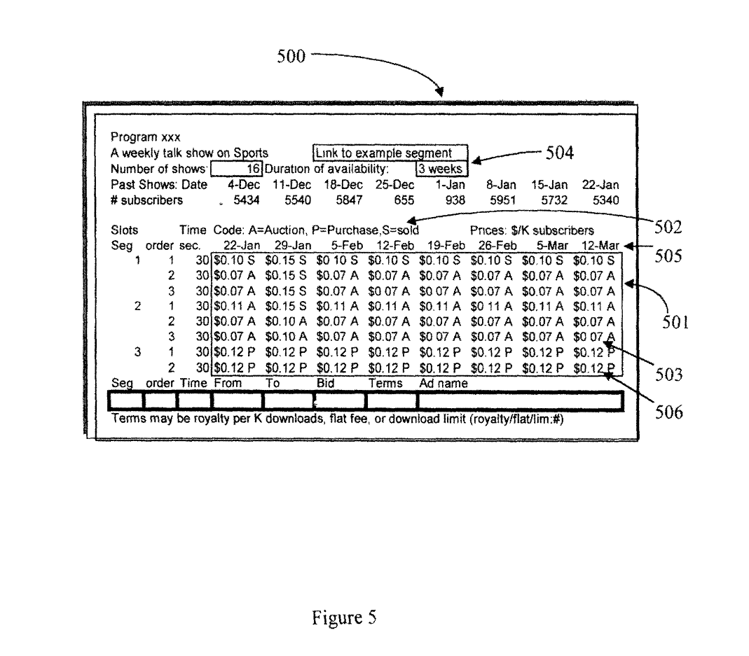

In the preferred embodiment, the Automatic Control System(100) comprises an integrated data base that keeps track of the status of all programs, segments, ads, producers, advertisers, listener subscriptions, listener/consumer requests, current ad slot prices, and statistical and financial information on all of the above. As mentioned above, the ACS publishes a heirarchy of program web pages, one such example (500) in FIG. 5 shows the number of available ad slots(501), whether an ad slot or program is available for auction or purchase(502), the current price(503), and statistics on the number of listeners in the past(504), recalled from data collected and stored in the integrated database, and other useful sponsor information. The programs are categorized by the topics of their contents, and the number of available ad slots. Listener and consumer statistics are also provided for each category. Category listings also include the current prices and numbers of category ads. Advertisers can bid for or otherwise purchase specific ad slots or specific programs. A record keeping means stores all data in the integrated database (100) and used later for providing sponsors with statistics of consumer demand for said audio or multimedia content.

A separate set of web pages exists for the owners of ad slots or programs. These web pages allow them to add or remove ad slots in the programs or segments that they own, for auction or for sale. The system keeps track of all financial transactions, bills the buyer and pays the seller, less our fees. Advertisers can also bid on category ad exposure rather than specific ad slots. Their ads will be placed in available ad slots in programs in the categories they requested for the amount of listeners they specify. The assignment of ads to ad slots is made prior to release of the programs by the Broadcast Center based on the highest category auction price, or current ownership. This process is effectuated in the business logic for the program composer and provides the means for sponsors of advertising content to chose said available audio or multimedia content for the embedement of their advertising content based on consumer demand for said audio or multimedia content

In another embodiment the assignment of the controls for the program composer(114) is done dynamically on each listener's request. The requested program is then composed and released by the Broadcast center(102) for that listener only. This provides a means for consumers of audio and multimedia content to select and schedule mode and method of playing that selection. The Automatic Control Center(100) also dynamically inserts promotional and public service ads in unsold or available ad slots(304).

In another embodiment the Automatic Control Center allocates the total revenue for category ads among the owners of all the available category ad slots. One such method of allocation is to divide the total revenue for category ads by the total number of listeners to the programming in that category. Each owner of a category ad slot would be allocated revenue equal to the number of listeners of their ad slot times the revenue per listener.

The content producer defines the duration of time that a program or series of programs will be available on the Broadcast center(504), and when the programs begin(505). Each ad slot in the program is available for that duration. The owner of the ad slot may sell the ad slot or auction it, as may the buyer of any ad slot, in turn. The owner may specify a starting or minimum asking price(506) and all legitimate bids must equal or exceed that minimum. The producer is obligated to provide the program at the time and for the contract duration. The auction ends shortly before the time the program is available. Ads must also be available before that time. Unfilled ad slots are made available for category ads. In one embodiment above, the category ads are filled on a listener by listener basis, highest price first. The content producer is effectively leasing out the program for the contracted duration, after which the ownership reverts back to the content producer. At the end of the contracted duration the Automatic Control Center deletes the program from the lease database table. The content provider can then lease out the program for another duration, at which time all its ad slots can again be sold or auctioned by the content producer (or the current owner for the new broadcast). The Automatic Control System (100) maintains a database of all requested content and selected distributions made enabling sponsors to make informative decisions purchasing allocated advertising slots based on said consumer demand. This provide a feedback loop responsive to consumer demand for selected audio or multimedia program content for setting prices for the ad slots which generate revenue for the owners based on consumer demand. In this manner, consumers receive requested audio or multimedia content for which payment is borne by sponsors of embedded advertisements.

Another web page may provide means for consumers of said audio or multimedia content to apply intelligent searches to find, identify, select, schedule, chose mode and method of package stream format compatable with said consumer player/viewer device. These consumer (108) requests are managed by a search engine, business logic applied in the ACS (100) in conjunction with the integrated database and dynamically updated webpage programs.

In another embodiment, the content producer can provide the program for sale on the market, which is provided by the Automatic Control Center(100). This sale can only occur after completing a contracted duration on the Automatic Control Center(100), or prior to making any contract to release the program to the Automatic Control Center(100) In yet another embodiment our system can act as the market for another broadcast center, such as a television or radio station, cable or satellite channel. The other Broadcast Center(102) may own the programming, lease it for the duration of their broadcasting, or charge an additional fee to the owner. The target broadcaster can be added to the information about the program and ad slots. The statistics on number of listeners or viewers is specific to the target broadcaster. In this way the Control System(100) and Composer(101) can be used to create a general market for programs, both audio and multimedia.

Scope

While the invention has been described and illustrated in connection with what are presently considered to be the most practical and preferred embodiments, it is to be understood that the invention is not limited to the disclosed embodiments, but on the contrary, is intended to cover various modifications and equivalent arrangements included within the scope of the appended claims. For example, the foregoing embodiments make use of the MPEG-4 standard of low bit rate coding for multimedia applications. It is anticipated that new coding techniques enabling even higher compression than current MPEG techniques will be developed. However, in such applications the present invention still provides a mechanism for distribution of audio and multimedia programs, including the buying, selling, integrating of selected advertising into the programs, and distributing programs to consumers over the Internet.

Therefore, persons of ordinary skill in this field are to understand that other equivalent technologies enabling coded representation of media objects may be utilized in the present system without departing from the scope of the invention, and that all such equivalent arrangements and modifications are to be included within the scope of the following claims.

We claim:

1. A system for facilitating and conducting production, market making and distribution of audio/multimedia content over a computer network linked to a central exchange website for providing consumers with audio/multimedia packaged programs from owners of said multimedia content through sponsor supported embedded advertising content in the packaged programs comprising:
means for owners of audio/multimedia content to load said content onto the exchange website;
means for sponsors of advertising content to load advertising content to the exchange website for merging with said audio/multimedia content to provide standard packaged programs for viewer/player device formats;
selection means for consumers to select and schedule mode and method of playing said packaged programs on a player/viewer device;
record keeping means responsive to selection means for providing a data record of consumer selected programs; and
Automatic Control System means responsive to the record keeping means for setting prices for allocated advertising slots based on said consumer demand, such that sponsors chose available audio/multimedia content for the embedment of advertising content based upon consumer demand and consumers receive audio/multimedia content paid for by sponsors of embedded advertisements.

2. System as in claim 1 wherein said selection means further comprises search means for enabling consumers of said audio/multimedia content to identify, select, schedule, and chose mode and method of package stream format compatable with said consumer player/viewer device.

3. A system according to claim 1 further comprising means, responsive to said record keeping means, for determining sponsor advertising slot rates, wherein slot rates comprise an ad slot price structure with respect to a time period of consumer demand.

4. A system provided on a communication network linked to an exchange portal for electronically identifying and merging owner audio/multimedia content with sponsor content and transmitting the merged stream of content to consumers in compatable standard digital formats comprising:
a plurality of owner audio/multimedia content providers communicatively linked over the network and the exchange portal;
a search engine means, provided in the exchange portal, for generating one or more searches for audio/multimedia content requested by said consumers over said communication network;
a means responsive to the search engine means for collecting consumer request information to thereby set ad slot pricing for sponsors of the merged content stream, such that consumers using said communication network obtain selected audio/multimedia content by accessing the portal service and receive said integrated content paid for by sponsor embedded advertisements.

5. A system for receiving integrated streams of audio/multimedia content paid for by sponsors using an auction system for allocating advertising slot pricing per consumer transaction comprising:
an exchange website providing a repository of audio/multimedia content available to consumers;
record keeping means communicatively linked with the website for providing sponsors with statistics of consumer transactions for said audio/multimedia content;
means for sponsors to load advertising content onto said exchange website for merging with audio/multimedia content to provide packaged programs in standard viewer/player device formats requested by consumers;
means for sponsors to chose said available audio/multimedia content for the embedment of advertising based on consumer transactions for said audio/multimedia content;
means for integrating said audio/multimedia content with sponsor advertising and formatting the integrated content into standard audio/multimedia streams compatible with consumer player/viewer devices;
means for consumers to select the integrated audio/multimedia content for playback; and
Automatic Control System means responsive to the record keeping means for setting prices for allocated advertising slots based on consumer demand.

6. A system for facilitating and conducting production, market creation and distribution of audio or multimedia content over the Internet through an Internet based central exchange for providing consumers with audio/multimedia programs through sponsor supported advertising embedded in said programs comprising:
a website providing an exchange for authors and owners of audio/ multimedia program, to make the programs available to consumers, each program comprising one or more embedded advertising slots;
record keeping means communicatively linked with the website for enabling sponsors to know the distribution of audio/multimedia programs selected by consumers; and
feedback means, linked with a means for providing sponsors with said embedded advertising slots, said feedback means for providing a record of the number of times selected audio/multimedia programs are downloaded, such that available embedded advertising slots can be competitively priced to sponsors based on consumer distribution.
